(19) United States
(12) Patent Application Publication
(10) Pub. No.: US 2026/0145568 A1
(43) Pub. Date: May 28, 2026

(54) APPARATUS AND METHOD FOR OPERATING VEHICLE-TO-GRID (V2G) FOR AN ELECTRIC VEHICLE

(71) Applicants: HYUNDAI MOTOR COMPANY, Seoul (KR); KIA CORPORATION, Seoul (KR)

(72) Inventors: Jiyeong Seo, Hwaseong-si (KR); Yunjeong Nam, Hwaseong-si (KR); Donggil Ha, Hwaseong-si (KR); Min-gyu Park, Hwaseong-si (KR)

(73) Assignees: HYUNDAI MOTOR COMPANY, Seoul (KR); KIA CORPORATION, Seoul (KR)

(21) Appl. No.: 19/207,505

(22) Filed: May 14, 2025

(30) Foreign Application Priority Data
Nov. 28, 2024 (KR) 10-2024-0173762

(51) Int. Cl. B60L 53/63; B60L 53/62; B60L 55/00; B60L 58/13; B60L 58/14

(52) U.S. Cl. CPC B60L 53/63; B60L 53/62; B60L 55/00; B60L 58/13; B60L 58/14

(57) ABSTRACT

An electric vehicle V2G operating apparatus and an electric vehicle V2G operating method are disclosed. The electric vehicle V2G operating apparatus includes a communication unit configured to receive information about a power load at every hour from a server. The apparatus further includes an SOC measuring unit configured to measure a state of charge (SOC) of the battery pack. The apparatus further includes a V2G operating unit configured to operate a vehicle to grid (V2G) based on information about a power load at every hour and SOC information of the battery pack.

### CROSS-REFERENCE TO RELATED APPLICATION

This application claims the benefit of and priority to Korean Patent Application No. 10-2024-0173762, filed Nov. 28, 2024, in the Korean Intellectual Property Office, the entire disclosure of which is incorporated herein by reference.

### TECHNICAL FIELD

The present disclosure relates to an apparatus and a method for operating a vehicle to grid (V2G) of an electric vehicle and an electric vehicle V2G method.

### BACKGROUND

As the distribution of electric vehicles equipped with high-capacity batteries increases, the demand for electricity required for charging is also rapidly increasing. This places a heavy burden on the power infrastructure and requires continued expansion of charging infrastructure. However, the actual usage time of electric vehicles in a day is on average only about 4%, so that the charged electricity remains idle for most of the time. This inefficient power operation wastes resources of a power supply network and prevents a potential economic value of the electric vehicle from being fully utilized.

Accordingly, a vehicle to grid (V2G) technology was introduced to connect batteries of the electric vehicle to the power grid to transmit and receive energy in both directions. According to the V2G technology, the electric vehicle battery is utilized as an energy storage device to return unconsumed energy to a power grid to supply the electricity in hours with a high power demand or to store the renewable energy. This method attracts attention as a way to increase the efficiency of the electric vehicle, improve the stability of the power grid, and further achieve the economic benefits.

However, according to the V2G technology of the related art, when the usage range of the state of charge (SOC) of the electric vehicle battery is not appropriately controlled, in a high SOC state or a fully discharged state of the battery, the V2G function may end. In such cases, the battery is left in undesirable conditions for a long time to accelerate the deterioration of the battery, which causes the decrease of the economic value of the electric vehicle. Specifically, when the battery is left in a fully discharged state for a long time, the battery remains discharged when the user tries to use the vehicle, which not only causes the inconvenience in using the vehicle, but also has a serious adverse impact on the battery life.

Accordingly, in order to more efficiently operate the electric vehicle V2G technology and preserve the battery life, a necessity for a technology to appropriately control the SOC usage range is raised. The subject matter described in this background section is intended to promote an understanding of the background of the disclosure and thus may include subject matter that is not already known to those of ordinary skill in the art.

### SUMMARY

The present disclosure provides a vehicle to grid (V2G) operating apparatus and a V2G method of an electric vehicle. The apparatus and the method may suppress excessive deterioration of the battery caused by the V2G use compared to when the V2G is not used.

The present disclosure provides an electric vehicle V2G operating apparatus and an electric vehicle V2G method, which may delay the deterioration of the battery by appropriately controlling a battery usage SOC range and a depth of discharge (DOD) by limiting a V2G usage range to be different in every SOC range during the operation of V2G.

The present disclosure also provides an electric vehicle V2G operating apparatus and an electric vehicle V2G method, which may operate the V2G in the on-peak load hours using information about the power load at every hour and may charge the battery in super off-peak load hours to increase the economic efficiency.

The present disclosure are not limited to the above-mentioned object. Other objects and advantages of the present disclosure, which are not mentioned, should be understood through the following description, and should become apparent from embodiments of the present disclosure. It should be also understood that the objects and advantages of the present disclosure may be realized by means and combinations thereof set forth in the present disclosure.

In order to achieve the above-described objects, according to an aspect of the present disclosure, a vehicle-to-grid (V2G) operating apparatus for an electric vehicle includes a communication unit configured to receive information about a power load at every hour from a server. The V2G operating apparatus further includes an SOC measuring unit configured to measure a state of charge (SOC) of the battery pack. The V2G operating apparatus further includes a V2G operating unit configured to operate a V2G based on the information of the power load and SOC information of the battery pack. The V2G operating unit is further configured to determine whether an operation start time of the V2G falls within on-peak load hours of the information of the power load. The V2G operating unit is further configured to control the battery pack to be charged in super off-peak load hours after ending V2G operation.

When the operation start time of the V2G falls within the on-peak load hours of the information of the power load, the V2G operating unit may operate the V2G. The SOC measuring unit may measure a current flowing through the battery pack to determine a charged state and a discharged state. The SOC measuring unit may measure a voltage change of each cell of a plurality of cells of the battery pack to predict an SOC variation of the battery pack to predict an SOC variation of the battery pack.

The V2G operating unit may, when operating the V2G, vary an operating method of the V2G based on the SOC range defined by an SOC control strategy to which an SOC value of the battery pack at the operation start time of the V2G belongs.

The SOC range may include a first reference value and a second reference value and is divided into a high SOC range, a medium SOC range, and a low SOC range, based on the first reference value and the second reference value.

When the SOC value of the battery pack at the operation start time of the V2G falls within the high SOC range, the V2G operating unit may operate the V2G with the predetermined value as a maximum DoD value.

When the SOC value of the battery pack at the operation start time of the V2G falls within the medium SOC range, the V2G operating unit may operate the V2G with a differentiated value of the second reference value in the SOC of the battery pack at the operation start time of the V2G as a maximum DoD value.

When the SOC value of the battery pack at the operation start time of the V2G falls within the low SOC range, the V2G operating unit may end the operation of the V2G and may perform the charging by checking whether the charging is performed.

In the meantime, according to another aspect of the present disclosure, a V2G operating method for an electric vehicle includes receiving information about a power load at every hour from a server. The method further includes measuring a state of charge (SOC) of the battery pac. The method further includes a step of operating a V2G based on the information of the power load and SOC information of the battery pack. The method further includes determining whether an operation start time of the V2G falls within on-peak load hours of the information of the power load. The method further includes controlling the battery pack to be charged in super off-peak load hours after ending V2G operation.

Operating the V2G includes: when the operation start time of the V2G falls within the on-peak load hours of information of the power load, operating the V2G. The V2G operating method may further include measuring a current flowing through the battery pack to determine a charged state and a discharged state. The V2G operating method may further include measuring a voltage change of each cell of a plurality of cells of the battery pack to predict an SOC variation of the battery pack to predict an SOC variation of the battery pack.

Operating the V2G includes: changing an operating method of the V2G based on an SOC range defined by an SOC control strategy to which an SOC value of the battery pack at the V2G operation start time of the V2G belongs.

According to the present disclosure, excessive deterioration of the battery caused when the V2G is used as compared with the case when the V2G is not used may be suppressed.

Further, according to the present disclosure, the deterioration of the battery is delayed by appropriately controlling a battery usage SOC range and a depth of discharge (DOD) by limiting a V2G usage range to be different in every SOC range during the operation of V2G.

Further, according to the present disclosure, the V2G is operated in the on-peak load hours using information about the power load at every hour and the battery is charged in super off-peak load hours to increase the economic efficiency.

### BRIEF DESCRIPTION OF THE DRAWINGS

The above and other aspects, features, and advantages of the present disclosure should become apparent from the detailed description of the following aspects in conjunction with the accompanying drawings, in which:

FIG. 1 is a diagram of a vehicle to grid V2G operating apparatus of an electric vehicle according to an embodiment of the present disclosure;

FIG. 2 is a flowchart before operation manners are divided in a V2G operating method of an electric vehicle according to an embodiment of the present disclosure;

FIG. 3 is a view illustrating a state of charge (SOC) range on the SOC control strategy according to an embodiment of the present disclosure;

FIG. 4 is a V2G operation flowchart when a start SOC value of a battery pack is in a high SOC range in an electric vehicle V2G operating method according to an embodiment of the present disclosure;

FIG. 5 is a V2G operation flowchart when a start SOC value of a battery pack is in a medium SOC range in an electric vehicle V2G operating method according to an embodiment of the present disclosure;

FIG. 6 is a V2G operation flowchart when a start SOC value of a battery pack is in a low SOC range in an electric vehicle V2G operating method according to an embodiment of the present disclosure; and

FIG. 7 is a flowchart after ending V2G operation in an electric vehicle V2G operating method according to an embodiment of the present disclosure.

### DETAILED DESCRIPTION

Hereinafter, reference is made in detail to embodiments of the present disclosure, examples of which are illustrated in the accompanying drawings and described below. The same or similar elements are denoted by the same reference numerals even though the elements are depicted in different drawings and thus a redundant description thereof has been omitted. In the following description of the embodiments, the terms, such as “module”, and “part”, are provided or used interchangeably for convenience. The terms do not have meanings or functions distinguished from one another. In the following description of the embodiments of the present disclosure, a detailed description of known functions and configurations incorporated herein has been omitted when the detailed description may make the subject matter of the present disclosure rather unclear. Further, the accompanying drawings are given to describe the embodiments of the present disclosure and should not be construed as being limited to the embodiments set forth herein. It should be understood that the embodiments of the present disclosure are only intended to disclose the present disclosure and cover modifications, equivalents, or alternatives, which should fall within the scope and technical range of the present disclosure.

In the following description of the embodiments, terms, such as “first” and “second”, are used only to describe various elements, and these elements should not be construed as being limited by these terms. These terms are used only to distinguish one element from other elements.

When an element or a layer is referred to as being “connected to” or “coupled to” another element or another layer, the element or the layer may be directly connected or coupled to the other element or layer, or intervening elements or layers may be present therebetween. In contrast, when an element or layer is referred to as being “directly connected to” or “directly coupled to” another element or layer, there may be no intervening elements or layers present therebetween. When a controller, unit, module, component, device, element, or the like of the present disclosure is described as having a purpose or performing an operation, function, or the like, the controller, unit, module, component, device, element, or the like should be considered herein as being “configured to” meet that purpose or to perform that operation or function. Each controller, unit, module, component, device, element, and the like may separately embody or be included with a processor and a memory, such as a non-transitory computer readable media, as part of the apparatus.

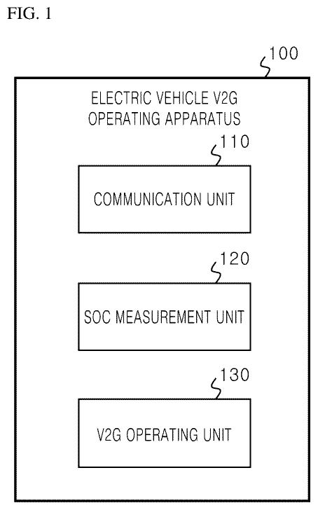

Hereinafter, an vehicle to grid (V2G) operating apparatus and an V2G operating method of an electric vehicle according to the present disclosure are described in detail with reference to FIGS. 1-7.

FIG. 1 is a diagram of an electric vehicle V2G operating apparatus according to an embodiment of the present disclosure. Referring to FIG. 1, an electric vehicle V2G operating apparatus 100 according to an embodiment of the present disclosure includes a communication unit 110 (e.g., a communicator, a transceiver), a state of charge (SOC) measurement unit 120, and an operating unit 130 (e.g., a processor).

The communication unit 110 receives information about a power load at every hour from the server.

For example, the server may be a power data open portal server operated by Korea Electric Power Corporation (KEPCO). The communication unit 110 may receive real-time information, such as a power demand, a supply amount, and electricity market price in every hour, from the server. Specifically, the communication unit 110 may be provided with power load data at every 15 minutes or every one hour, an electricity rate at every hour, or power peak hour information through a power supply company Open API, e.g., the Korea Electric Power Corporation OpenAPI.

For reference, in the following Table 1, power load at every hour is exemplified.

TABLE 1

| | | Spring and Fall | Winter |
|---|---|---|---|
| | Summer | (March to May | (November |
| | (June to | and September | to |
| | August) | to October) | February) |
| Super off-peak load | 22:00~08:00 | 22:00~08:00 | 22:00~08:00 |
| Off-peak load | 08:00~11:00 | 08:00~11:00 | 08:00~09:00 |
| | 12:00~13:00 | 12:00~13:00 | 12:00~16:00 |
| | 18:00~22:00 | 18:00~22:00 | 19:00~22:00 |
| On-peak load | 11:00~12:00 | 11:00~12:00 | 09:00~12:00 |
| | 13:00~18:00 | 13:00~18:00 | 16:00~19:00 |

At this time, on Saturdays, consumed electricity in on-peak load hours is measured as off-peak load hours, and the maximum demanded power and consumed electricity on holidays are measured as super off-peak load hours.

The SOC measurement unit 120 measures an SOC value of the battery pack.

For example, the SOC measurement unit 120 includes a plurality of current sensors, voltage sensors, and temperature sensors and collects accurate status information through a plurality of cells of the battery pack. The current sensor measures a current flowing through a battery pack to find out a charged and discharged state and the voltage sensor measures a voltage change of each cell to predict an SOC variation of the battery pack. Further, the temperature sensor senses temperature rise or overheating of the cell and the module to provide control data for ensuring thermal stability.

Further, the SOC measurement unit 120 measures the SOC value based on information generated by measuring physical variables, such as a current, a voltage, and a temperature of the battery pack in real time.

The V2G operating unit 130 operates the vehicle to grid (V2G) based on information about power load at every hour and SOC information of the battery pack.

Specifically, if the V2G operation start time belongs to the on-peak load hours of the information about the power load at every hour, the V2G operating unit 130 operates the V2G. If the V2G operation start time does not belong to the on-peak load hours, the V2G operating unit 130 performs the charging without operating the V2G.

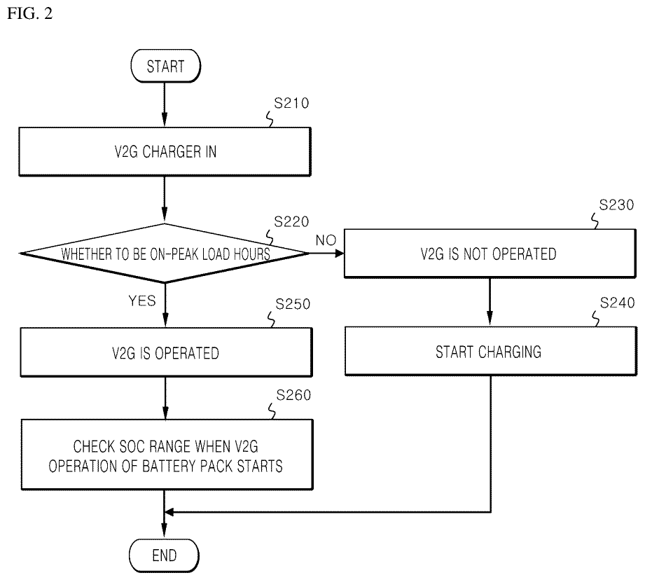

FIG. 2 is a flowchart before operating manners are divided in an electric vehicle V2G operating method according to an embodiment of the present disclosure.

Referring to FIG. 2, when the V2G charger is inserted (step S210 of FIG. 2), the V2G operating unit 130 checks hours when the on-peak load occurs in the power load at every hour and determines whether a time to start the V2G operation (“V2G operation start time”) belongs to the on-peak load hours (step S220 of FIG. 2).

This is to maximize the economic effect of V2G operation. In order to increase the economic efficiency of V2G operation, deterioration of the battery pack and the resulting cost need to be carefully considered, and it is desirable to operate the V2G in the on-peak load hours to reduce the cost burden. The V2G operating unit 130 sells the electricity when the unit price of the electricity suppled to the power grid is the highest by operating the V2G in the on-peak load hours to maximize profits and minimize the economic losses due to the deterioration of the battery pack.

If the V2G operation start time does not belong to the on-peak load hours (NO in step S220 of FIG. 2), the V2G operating unit 130 limits the V2G operation (step S230 of FIG. 2) and instead, the charging of the battery pack is preferentially performed to allow the user to use the vehicle without the inconvenience (step S240 of FIG. 2).

If the V2G operation start time belongs to the on-peak load hours (YES in step S220 of FIG. 2), the V2G operating unit 130 operates the V2G to transmit the power from the battery to the external power grid (step S250 of FIG. 2). The power is supplied in the on-peak load hours to increase the stability and the efficiency of the power grid and ensure the economic efficiency. Further, when the V2G is operated, the V2G operating method is different according to the SOC range on a SOC control strategy to which the SOC value of the battery pack at the V2G operation start time (“start SOC value”) belongs, so that the V2G operating unit 130 checks which SOC range on the SOC control strategy the SOC at the V2G operation start time belongs to (step S260 of FIG. 2).

For example, the larger a depth of discharge (DoD) is, the more the battery pack deteriorates so that when the V2G is used as much as the reduced DoD, a time left in a high SOC state is increased to adversely affect the deterioration. Therefore, the V2G operating unit 130 may set a different DoD limit value according to the SOC range on the SOC control strategy to which the SOC value of the battery pack at the V2G operation start time belongs.

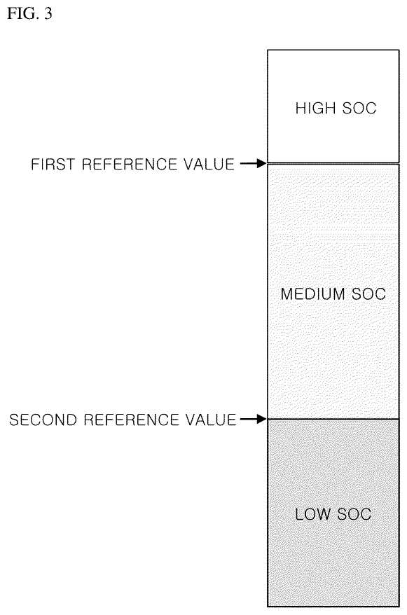

In an embodiment, the SOC range on the SOC control strategy includes a first reference value and a second reference value and is divided into a high SOC range, a medium SOC range, and a low SOC range, based on the first reference value and the second reference value (see FIG. 3).

Specifically, the first reference value is a SOC value set by subtracting a predetermined value from a maximum SOC value of the battery pack. Here, a predetermined value is a DoD value. The DoD value is set to enable the V2G operation in a high SOC region and is determined by deriving a DoD value at which the electricity sales revenue is maximum as compared with the economic loss due to the deterioration of the battery pack to maximize the economic efficiency of the V2G operation while minimizing the deterioration of the battery pack by testing various average SOC values based on the start SOC value of 100.

Further, by considering that deterioration occurs differently according to the location of the middle point when the DoD is the same, a point when the deterioration and the discharging of the battery pack is accelerated when charging and discharging are repeated with a constant DoD below the first reference value through an experiment is found to be set as a second reference value. Next, if the SOC value of the battery pack at the V2G operation start time belongs to the high SOC range, the V2G operating unit 130 operates the V2G by setting the predetermined value to the maximum DoD value.

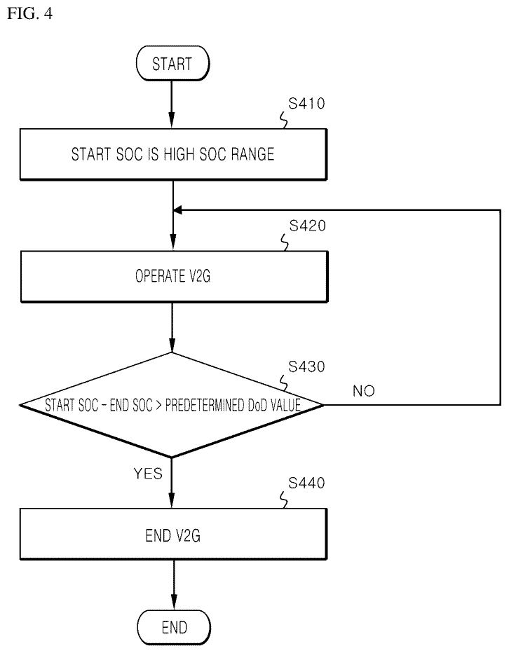

FIG. 4 is a V2G operation flowchart when a start SOC value of a battery pack is in a high SOC range in an electric vehicle V2G operating method according to an embodiment of the present disclosure.

Referring to FIG. 4, if the V2G is operated in the high SOC range (step S410 of FIG. 4), the V2G operating unit 130 operates the V2G (step S420 of FIG. 4) and prevents a value obtained by subtracting a SOC value of the battery pack at the V2G operation end time (“end SOC value”) from the start SOC value of the battery pack from exceeding a predetermined DoD value (step S430 of FIG. 4). Further, when the value reaches or is higher than a predetermined DoD value (YES in S430 of FIG. 4), the V2G operating unit 130 ends the V2G operation and is on standby (see step S440 of FIG. 4).

Further, if the SOC value of the battery pack at the V2G operation start time belongs to the medium SOC range, the V2G operating unit 130 operates the V2G with a differentiated value of the second reference value in the SOC value of the battery pack at the V2G operation start time as a maximum DoD value.

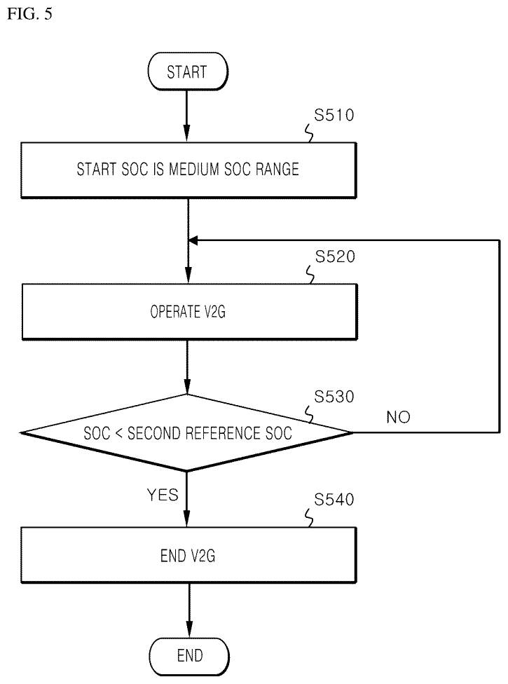

FIG. 5 is a V2G operation flowchart when a start SOC value of a battery pack is in a medium SOC range in an electric vehicle V2G operating method according to an embodiment of the present disclosure.

Referring to FIG. 5, when the V2G is operated in the medium SOC range (step S510 of FIG. 5), the V2G operating unit 130 operates the V2G (step S520 of FIG. 5) to the limit of the second reference SOC value, so that the end SOC value is higher than the second reference SOC value, by determining whether the end SOC value is lower than the second reference SOC value (step S530 of FIG. 5). Further, when the SOC value of the battery pack reaches or is lower than the second reference SOC value (YES in step S530 of FIG. 5), the V2G operating unit 130 ends the V2G operation and is on standby (step S540 of FIG. 5).

Further, if the SOC value of the battery pack at the V2G operation start time belongs to the low SOC range, the V2G operating unit 130 ends the operation of the V2G and checks whether to perform the charging.

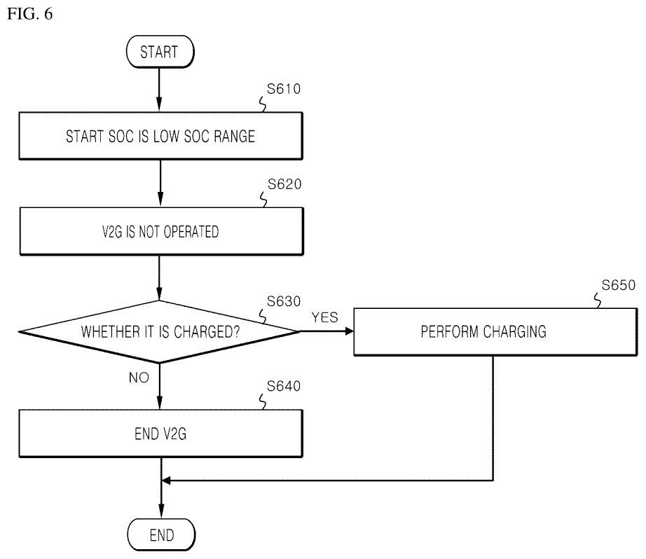

FIG. 6 is a V2G operation flowchart when a start SOC value of a battery pack is in a low SOC range in an electric vehicle V2G operating method according to an embodiment of the present disclosure.

Referring to FIG. 6, when the V2G operating unit 130 operates the V2G in the low SOC range (step S610 of FIG. 6), the V2G operating unit 130 receives a confirmation from the user about whether to perform the charging (step S630 of FIG. 6) without operating the V2G (step S620 of FIG. 6). If the user does not want to charge (NO in step S630 of FIG. 6), the V2G operating unit 130 is on standby with V2G operation stopped (step S640 of FIG. 6. If the user wants to charge (YES in step S630 of FIG. 6), the V2G operating unit 130 performs charging (step S650 of FIG. 6).

Further, after ending the V2G operation, if the V2G operation end time belongs to the super off-peak load hours of information about the power load at every hour, the V2G operating unit 130 performs charging. If the V2G operation end time does not belong to the super off-peak load hours, the V2G operating unit 130 enters a standby state.

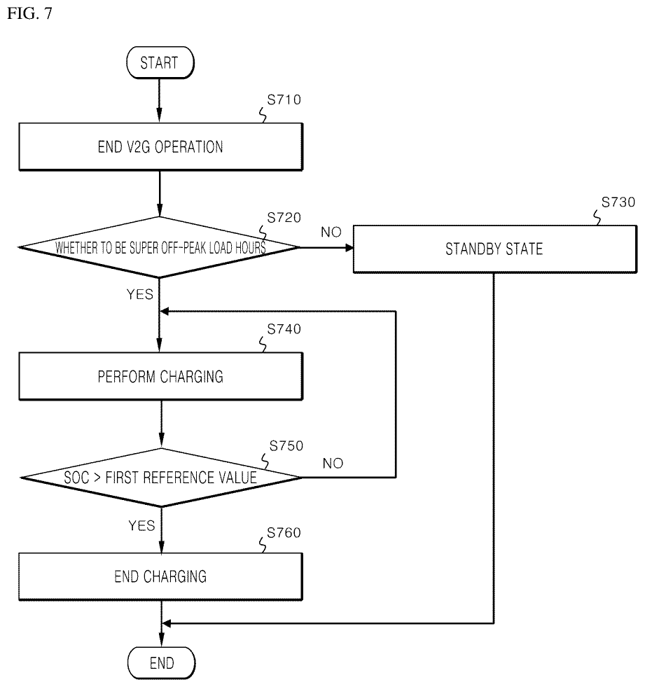

FIG. 7 is a flowchart after ending V2G operation in an electric vehicle V2G operating method according to an embodiment of the present disclosure.

Referring to FIG. 7, in a standby state after ending the V2G operation (step S710 of FIG. 7), the V2G operating unit 130 checks whether a current time belongs to the super off-peak load hours of the power load information at every hour (step S720 of FIG. 7). If the current time does not belong to the super off-peak load hours (NO in step S720 of FIG. 7), the V2G operating unit 130 is on standby (step S730 of FIG. 7). If the current time belongs to the super off-peak load hours (YES in step S720 of FIG. 7), the V2G operating unit performs charging to ensure the economic efficiency (step S740 of FIG. 7).

The V2G operating unit 130 limits a charging range of the battery pack by determining whether the SOC value of the battery pack exceeds the first reference value (step S750 of FIG. 7). If the SOC value of the battery pack exceeds the first reference value (YES in step S750 of FIG. 7), the V2G operating unit ends the charging (step S760 of FIG. 7) to reduce the deterioration of the battery pack and prevent the overheating and enhance the stability.

In the present disclosure, the elements may be in a singular form or in a plural form. In addition, when a range is stated in the present disclosure, the statement includes the embodiments to which individual values within the range are applied (unless there is a statement to the contrary) and is the same as a statement of the individual values constituting the range in the detailed description of the present disclosure.

Unless there is a statement of an explicit order or a statement to the contrary regarding steps constituting the method according to the present disclosure, the steps may be performed in any appropriate order. The present disclosure is not necessarily limited by the described order of the steps. Use of any examples or illustrative terms in the present disclosure is merely to describe the present disclosure in detail, and unless limited by the claims, the scope of the present disclosure is not limited by the examples or illustrative terms. Further, those having ordinary skill in the art should appreciate that various modifications, combinations, and changes may be made according to design conditions and factors within the scope of the appended claims or their equivalents.

Therefore, the spirit of the present disclosure should not be limited to the above-described embodiments, and the scope of the appended claims described below as well as all scopes equivalent to or equivalently changed from the claims are within the scope of the present disclosure.

1. A vehicle-to-grid (V2G) operating apparatus for an electric vehicle, the V2G operating apparatus comprising:
a communication unit configured to receive information about a power load at every hour from a server;
a state of charge (SOC) measuring unit configured to measure an SOC of a battery pack; and
a V2G operating unit configured to:
operate a V2G based on the information of the power load and SOC information of the battery pack;
determine whether an operation start time of the V2G falls within on-peak load hours of the information of the power load; and
control the battery pack to be charged in super off-peak load hours after ending V2G operation.

2. The V2G operating apparatus according to claim 1, wherein when the operation start time of the V2G falls within the on-peak load hours of the information of the power load, the V2G operating unit is configured to operate the V2G,
wherein the SOC measuring unit is further configured to:
measure a current flowing through the battery pack to determine a charged state and a discharged state; and
measure a voltage change of each cell of a plurality of cells of the battery pack to predict an SOC variation of the battery pack to predict an SOC variation of the battery pack.

3. The V2G operating apparatus according to claim 2, wherein the V2G operating unit, when operating the V2G, is configured to vary an operating method of the V2G based on the SOC range defined by an SOC control strategy to which an SOC value of the battery pack at the operation start time of the V2G belongs.

4. The V2G operating apparatus according to claim 3, wherein the SOC range includes a first reference value and a second reference value, and
wherein the SOC range is divided into a high SOC range, a medium SOC range, and a low SOC range, based on the first reference value and the second reference value.

5. The V2G operating apparatus according to claim 4, wherein the first reference value is a SOC value set by subtracting a predetermined value from a maximum SOC value of the battery pack, and
wherein the predetermined value is a DoD value configured to maximize an economic efficiency of the V2G operation while minimizing deterioration of the battery pack when discharging is performed at a maximum SOC value of the battery pack.

6. The V2G operating apparatus according to claim 4, wherein the second reference value is an SOC value at which discharging of the battery pack is accelerated and is set below the first reference value.

7. The V2G operating apparatus according to claim 5, wherein when the SOC value of the battery pack at the operation start time of the V2G falls within the high SOC range, the V2G operating unit is configured to operate the V2G with the predetermined value as a maximum DoD value.

8. The V2G operating apparatus according to claim 4, wherein when the SOC value of the battery pack at the operation start time of the V2G falls within the medium SOC range, the V2G operating unit is configured to operate the V2G with a differentiated value of the second reference value in the SOC of the battery pack at the operation start time of the V2G as a maximum DoD value.

9. The V2G operating apparatus according to claim 4, wherein when the SOC value of the battery pack at the operation start time of the V2G falls within the low SOC range, the V2G operating unit is configured to end the operation of the V2G and perform charging by checking whether the charging is performed.

10. The V2G operating apparatus according to claim 4, wherein the V2G operating unit is configured to limit a charging range, and
wherein the charging range has the first reference value as a maximum SOC value.

11. A vehicle-to-grid (V2G) operating method for an electric vehicle, the V2G operating method comprising:
receiving information about a power load at every hour from a server;
measuring a state of charge (SOC) of a battery pack;
operating a V2G based on the information of the power load and SOC information of the battery pack;
determining whether an operation start time of the V2G falls within on-peak load hours of the information of the power load; and
controlling the battery pack to be charged in super off-peak load hours after ending V2G operation.

12. The V2G operating method according to claim 11, wherein operating the V2G comprises:
when the operation start time of the V2G falls within the on-peak load hours of the information of the power load operating the V2G;
wherein the V2G operating method further comprises:
measuring a current flowing through the battery pack to determine a charged state and a discharged state; and
measuring a voltage change of each cell of a plurality of cells of the battery pack to predict an SOC variation of the battery pack to predict an SOC variation of the battery pack.

13. The V2G operating method according to claim 12, wherein operating the V2G comprising:
changing an operating method of the V2G based on an SOC range defined by an SOC control strategy to which an SOC value of the battery pack at the operation start time of the V2G belongs.

14. The V2G operating method according to claim 13, wherein the SOC range includes a first reference value and a second reference value, and
wherein the SOC range is divided into a high SOC range, a medium SOC range, and a low SOC range, based on the first reference value and the second reference value.

15. The V2G operating method according to claim 14, further comprising: setting a SOC value as the first reference value by subtracting a predetermined value from a maximum SOC value of the battery pack, and
wherein the predetermined value is a depth of discharge (DoD) value which maximizes an economic efficiency of the V2G operation while minimizing deterioration of the battery pack when discharging is performed at a maximum SOC value of the battery pack.

16. The V2G operating method according to claim 14, wherein the second reference value is an SOC value at which discharging of the battery pack is accelerated and is set below the first reference value.

17. The V2G operating method according to claim 15, wherein operating the V2G comprises:
based on determining that the SOC value of the battery pack at the operation start time of the V2G falls within the high SOC range, operating the V2G with the predetermined value as a maximum DoD value.

18. The V2G operating method according to claim 14, wherein operating the V2G comprises:
based on determining that the SOC value of the battery pack at the operation start time of the V2G falls within the medium SOC range, operating the V2G with a differentiated value of the second reference value in the SOC of the battery pack at the operation start time of the V2G as a maximum DoD value.

19. The V2G operating method according to claim 14, wherein operating the V2G comprises:
based on determining that the SOC value of the battery pack at the operation start time of the V2G falls within the low SOC range, ending the V2G operation and performing charging by checking whether the charging is performed.

20. The V2G operating method according to claim 14, wherein operating the V2G comprises:
limiting a charging range, and
wherein the charging range has the first reference value as a maximum SOC value.
